(19) United States
(12) Patent Application Publication
(10) Pub. No.: US 2010/0092159 A1
(43) Pub. Date: Apr. 15, 2010

(54) Video display system, video playback apparatus and display apparatus

(75) Inventor: Toru Okazaki, Chiba (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/587,086

(22) Filed: Oct. 1, 2009

(30) Foreign Application Priority Data
Oct. 3, 2008 (JP) P2008-258112

(51) Int. Cl. H04N 7/64

(52) U.S. Cl. 386/114; 386/E05.04

(57) ABSTRACT

A video display system includes: a video playback apparatus executing playback processing of video data and filter processing for removing noise from the video data; and a display apparatus performing display processing displaying video data played back by the video playback apparatus, and wherein video playback apparatus includes an adaptive filter processing circuit executing the filter processing to the video data and a filter-intensity determination circuit determining a filter intensity which is an intensity of the filter processing, and wherein the display apparatus includes a type notification unit transmitting display apparatus information which is information indicating the type of the display apparatus and/or the size of the display apparatus to the video playback apparatus, and wherein the filter-intensity determination circuit determines the filter intensity based on the display apparatus information transmitted from the type notification unit.

### CROSS-REFERENCE TO RELATED APPLICATION

The present application claims priority from Japanese Patent Application No. JP 2008-258112 filed in the Japanese Patent Office on Oct. 3, 2008, the entire content of which is incorporated herein by reference.

### BACKGROUND OF THE INVENTION

1. Field of the Invention

The present invention relates to a video display system, a video playback apparatus and a display apparatus which handle encoded digital video data.

2. Description of the Related Art

In recent years, a video playback apparatus handling video data as digital data, which is intended for effective information transmission/accumulation is becoming popular both in the information distribution side such as broadcasting stations and in the information reception side such as homes.

In such video playback apparatus, a video coding method which performs compression by orthogonal transforms such as a discrete cosine transform using redundancy peculiar to video information and motion compensation is used. As the video coding methods, for example, there are MPEG (Moving Picture Experts Group) and the like.

Particularly, MPEG2 (ISO/IEC13818-2) corresponds to both interface scanning video and progressive scanning video as well as both standard resolution video and high definition video, which is widely used as a general-purpose video coding method.

The MPEG2 compression method is widely used for coding of video data corresponding to high resolution and high picture quality such as mainly digital television broadcasting and optical disc media (DVD, BD (Blu-ray Disc: trademark and the like).

Furthermore, a coding method called JVT (Joint Video Team) and a coding method called VC-1 which realize a higher compression ratio are proposed, following the MPEG2 compression method.

In JVT and VC-1, techniques of motion compensation, orthogonal transforms such as the discrete cosine transform (DCT) and Hadamard transform, quantization which realizes the high compression ratio by quantizing obtained respective coefficients and the like are used.

When video data encoded by using techniques such as the motion compensation, the orthogonal transform and coefficient quantization is played back, processing of inverse quantization, inverse frequency transform and the like is performed to perform decoding.

In the coding method using techniques such as quantization described above, there is a problem that noise is generated due to a quantization error at the time of decoding.

Particularly, when the compression rate is made to be too high with respect to input video of scenes with vigorous motion, objects having extremely small pictures and the like, the quantization error is increased, as a result, noise is increased.

As a specific example of noise, there is a block noise in which level differences appear in a stand-out manner at boundaries of blocks which is units used when performing frequency transform due to the increase of the quantization error.

In order to make the block noise inconspicuous, the video playback apparatus performs, for example, processing of filtering boundaries of blocks after decoding the encoded video signal.

As such filtering processing, for example, a technique disclosed in JP-A-2008-167456 (Patent Document 1) can be cited.

### SUMMARY OF THE INVENTION

In Patent Document 1, a video coding device including a processor which selectively filters a boundary between two adjacent blocks in video is disclosed.

According to the video coding device of Patent Document 1, the processor selectively performs filtering by using motion prediction information and/or motion compensation information with respect to the adjacent video blocks.

In the adjacent video blocks, filtering is skipped when the motion prediction information is sufficiently similar to the motion compensation information.

Video data played back by a device which plays back video will be displayed on a display apparatus such as a liquid crystal display.

The block noise due to the video compression technique using the above-described coding method differs in the degree of conspicuousness according to the type or size of monitors.

In the monitors of the liquid crystal display, a plasma display and the like, the block noise generally tends to be more conspicuous as compared with a CRT display, a projector and the like.

In the monitors of the same type, the block noise tends to be more conspicuous as the size of the screen becomes larger.

When the filter processing for making the block noise inconspicuous is performed in the video playback apparatus, adverse effects are sometimes generated such that small pictures or lines appear blurred, in addition to the effect of removing noise.

In the case that the display apparatus side is the liquid crystal display or the plasma display in which the block noise tends to be conspicuous, the effect of the filter processing is more likely to be obtained than adverse effects. However, in the case that the display apparatus side is the CRT or the projector in which the block noise tends to be inconspicuous, the adverse effects of the filter processing are more prominent than the effect of filter processing.

In view of the above, it is desirable to provide a video display system, a video playback apparatus and a display apparatus which can perform effective noise removal processing.

A video display system according to an embodiment includes a video playback apparatus executing playback processing of video data and filter processing for removing noise from the video data, and a display apparatus performing display processing displaying video data played back by the video playback apparatus, in which video playback apparatus has an adaptive filter processing circuit executing the filter processing to the video data and a filter-intensity determination circuit determining a filter intensity which is an intensity of the filter processing, in which the display apparatus has a type notification unit transmitting display apparatus information which is information indicating the type of the display apparatus and/or the size of the display apparatus to the video playback apparatus, and in which the filter-intensity determination circuit determines the filter intensity based on the display apparatus information transmitted from the type notification unit.

A video display system according to another embodiment of the invention includes a video playback apparatus executing playback processing of video data and filter processing for removing noise from the video data, and a display apparatus performing display processing displaying video data played back by the video playback apparatus, in which video playback apparatus has an adaptive filter processing circuit executing the filter processing to the video data, a filter-intensity determination circuit determining a filter intensity which is an intensity of the filter processing and a user interface which can select display apparatus information which is information indicating the type of the display apparatus and/or the size of the display apparatus, and in which the filter-intensity determination circuit determines the filter intensity based on the display apparatus information selected by the user interface.

A video display system according to still another embodiment of the invention includes a video playback apparatus executing playback processing of video data and filter processing for removing noise from the video data, and a display apparatus performing display processing displaying video data played back by the video playback apparatus, in which video playback apparatus has an adaptive filter processing circuit executing the filter processing to the video data and a filter-intensity determination circuit determining a filter intensity which is an intensity of the filter processing, in which the display apparatus has a type notification unit transmitting display apparatus information which is information indicating type of the display apparatus and/or the size of the display apparatus to the video playback apparatus, and in which the filter-intensity determination circuit determines the filter intensity based on the display apparatus information transmitted from the type notification unit and changes the filter intensity determined based on a quantized value calculated in the playback processing.

A video display system according to still another embodiment of the invention includes a video playback apparatus executing playback processing of video data and filter processing for removing noise from the video data, and a display apparatus performing display processing displaying video data played back by the video playback apparatus, in which video playback apparatus has an adaptive filter processing circuit executing the filter processing to the video data, a filter-intensity determination circuit determining a filter intensity which is an intensity of the filter processing and a user interface which can select display apparatus information which is information indicating the type of the display apparatus and/or the size of the display apparatus, and in which the filter-intensity determination circuit determines the filter intensity based on the display apparatus information selected by the user interface and changes the filter intensity determined based on a quantized value calculated in the playback processing.

A video playback apparatus according to still another embodiment of the invention, which is connected to a display apparatus which performs display processing displaying video data and executes playback processing of video data and filter processing for removing noise from the video data, has an adaptive filter processing circuit and a filter-intensity determination circuit determining a filter intensity which is an intensity of the filter processing, in which the filter-intensity determination circuit determines the filter intensity based on display apparatus information which is information indicating the type of the display apparatus and/or the size of the display apparatus, which is transmitted from the display apparatus.

A display apparatus according to still another embodiment of the invention which is connected to a video playback apparatus executing playback processing of video data and filter processing for removing noise from the video data includes a type notification unit notifying display apparatus information indicating the type of the display apparatus and/or the size of the display apparatus, which is information for determining a filter intensity as a filter processing intensity at the time of executing the filter processing with respect to the video data.

According to the embodiments of the invention, it is possible to perform effective noise removal processing.

### BRIEF DESCRIPTION OF THE DRAWINGS

FIG. 1 is a block diagram showing a configuration example of a video playback system according to a first embodiment;

FIG. 2 is a chart for explaining a filter-intensity determination table for determining a filter intensity based on display apparatus information acquired from a display apparatus;

FIG. 3 is a block diagram showing a configuration example of a video playback system according to a second embodiment;

FIG. 4 is block diagram showing a configuration example of a video playback system according to a third embodiment; and

FIG. 5 is block diagram showing a configuration example of a video playback system according to a fourth embodiment.

### DESCRIPTION OF THE PREFERRED EMBODIMENTS

Hereinafter, embodiments of the invention will be explained.

### First Embodiment

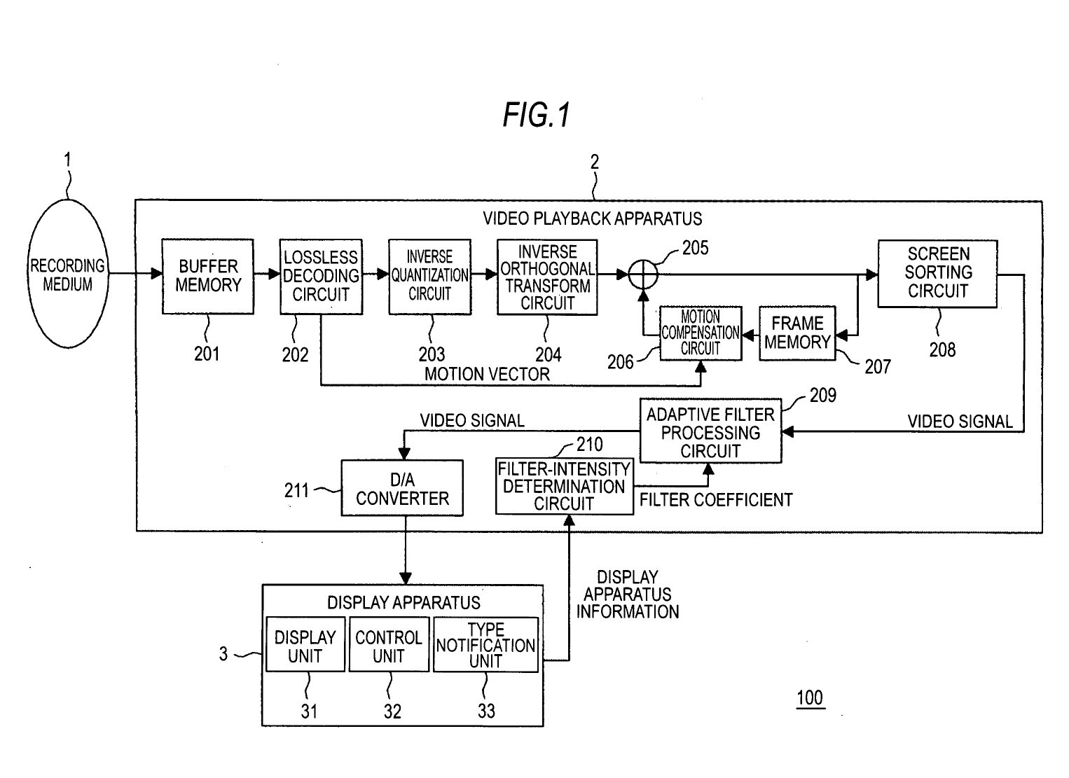

FIG. 1 is a block diagram showing a configuration example of a video playback system 100 according to an embodiment of the invention.

As shown in FIG. 1, the video playback system 100 includes a recording medium 1, a video playback apparatus 2 and a display apparatus 3.

The recording medium 1 is a recording medium which records digital video data and digital audio data such as digital optical discs, for example, a DVD (Digital Versatile Disc), a BD (Blu-ray Disc: trademark) and the like.

The video recording system 100 reads video data and the like recorded in the recording medium 1 by using, for example, an optical disc drive device and the like.

The video data recorded in the recording medium 1 is digital video data coded (compressed) by coding methods such as MPEG2, JVT and VC-1.

The video playback apparatus 2 is a processing block performing playback processing with respect to digital video data read from the recording medium 1.

The video playback apparatus 2 performs playback processing to the digital video data, outputting the data to the display apparatus 3 as a playback video signal.

The video playback apparatus 2 also performs noise removal processing for removing noise generated due to errors and the like in the digital video data at the time of performing playback processing of digital video data.

Execution of the noise removal processing of the video playback apparatus 2 is controlled in accordance with the type, size and the like of the display apparatus 3.

The display apparatus 3 is a monitor device for displaying the playback video signal outputted from the video playback apparatus 2.

The display apparatus 3 is formed by, for example, a CRT (Cathode Ray Tube) display, a projector, a liquid crystal display, a plasma display and the like.

As shown in FIG. 1, the video playback apparatus 2 includes a buffer memory 201, a lossless decoding circuit 202, an inverse quantization circuit 203, an inverse orthogonal transform circuit 204, an adder 205, a motion compensation circuit 206, a frame memory 207 and a screen sorting circuit 208.

The video playback apparatus 2 further includes an adaptive filter processing circuit 209, a filter-intensity determination circuit 210 and a D/A converter 211.

Video data is read from the recording medium 1 and inputted to the video playback apparatus 2 shown in FIG. 1.

The inputted video data is stored in the buffer memory 201 which stores inputted data temporarily.

The video data stored in the buffer memory 201 is outputted to the lossless decoding circuit 202.

The lossless decoding circuit 202 executes variable-length decoding processing, arithmetic decoding processing and the like based on a format of frame video data in the video data.

The lossless decoding circuit 202 outputs a quantized transform coefficient to the inverse quantization circuit 203 as the result of the above processing.

The lossless decoding circuit 202 also executes decoding of a motion vector stored in a header portion of the frame video data when the video data is inter-coded data.

The decoded motion vector is outputted from the lossless decoding circuit 202 to the motion compensation circuit 206.

The inverse quantization circuit 203 performs inverse quantization processing based on the quantized transform coefficient which has been outputted from the lossless decoding circuit, generating a transform coefficient.

The inverse orthogonal transform circuit 204 performs the inverse orthogonal transform such as an inverse discrete cosine transform or an inverse Karhunen-Loeve transform based on the transform coefficient generated by the inverse quantization circuit 203 by using the compression method of the video data.

In the case that video data inputted to the video playback apparatus 2 is inter-coded data, the motion compensation circuit 206 performs motion compensation processing.

In the inter coding, coding is performed by including inter-frame prediction in addition to data in respective frames of video data.

As a typical inter-frame prediction, for example, there is a method of motion compensation.

The motion compensation method is a method of compressing video data efficiently by detecting how elements recorded between continuous frames have moved when compressing video data.

The motion compensation circuit 206 acquires a motion vector from the lossless decoding circuit 202 and generates prediction video data based on the motion vector and reference video data stored in the frame memory 207.

The adder 205 adds the prediction video data generated by the motion compensation circuit 206 to the video data outputted from the inverse orthogonal transform circuit 204.

On the other hand, in the case that video data inputted to the video playback apparatus 2 is intra-coded data, video data outputted from the inverse orthogonal transform circuit 204 is stored in the screen sorting circuit 208.

In the intra coding, coding is performed only by data in each frame of video data, which is coding processing in which inter-frame prediction such as motion compensation is not performed.

The screen sorting circuit 208 performs processing of sorting respective frames of inter-coded video data outputted from the adder 205 and respective frames of intra-coded video data in a prescribed order. According to this, respective frames of video data are sorted so as to be played back in the normal order.

The adaptive filter processing circuit 209 performs filter processing for removing noise such as block noise with respect to the video data outputted from the screen sorting circuit 208.

At this time, the adaptive filter processing circuit 209 executes filter processing based on a filter intensity determined by the filter-intensity determination circuit 210.

The filter-intensity determination circuit 210 performs prescribed communication with the display apparatus 3, acquiring display apparatus information including the type, size and the like of the display apparatus 3 and determining the filter intensity based on the acquired display apparatus information.

Then, the D/A converter 211 performs digital/analog conversion of the video data to which filter processing (noise removal processing) is performed by the adaptive filter processing circuit 209, outputting the data to the display apparatus 3.

The display apparatus which has acquired video data converted into analog data performs display of the video data.

Hereinafter, respective components of the display apparatus 3 will be explained.

As shown in FIG. 1, the display apparatus 3 includes a display unit 31, a control unit 32 and a type notification unit 33.

The display unit 31 is a display device which displays video data in the display apparatus 3.

The control unit 32 controls the whole operation of the display apparatus 3 totally.

Specifically, the control unit 32 executes display processing which displays analog video data outputted from the video playback apparatus 2 on the display unit 31.

The control unit 32 transmits display apparatus information including the type, size and the like of the display device of the display apparatus 3 to the filter-intensity determination circuit 210 of the video playback apparatus 2 at a prescribed timing.

The prescribed timing may be, for example, a timing when a display apparatus information request is received from the video playback apparatus 2 or may be a moment when the display apparatus 3 is connected to the video playback apparatus 2 and mutual communication has established. The timing may also be a timing corresponding to a prescribed operation by a user with respect to the video playback apparatus 2 or the display apparatus 3. The prescribed timing is not particularly limited in the invention.

The display apparatus information transmitted by the type notification unit 33 is information including, for example, the type of the display device of the display apparatus 3, for example, the liquid crystal, the CRT, the plasma and the projector as well as the size of displays. The size of the display device is commonly represented, for example, by a method of representing the length of diagonal lines of the display device by the inch.

Next, a method of determining a filter intensity based on the display apparatus information acquired by the filter-intensity determination circuit 210 from the display apparatus 3 will be explained.

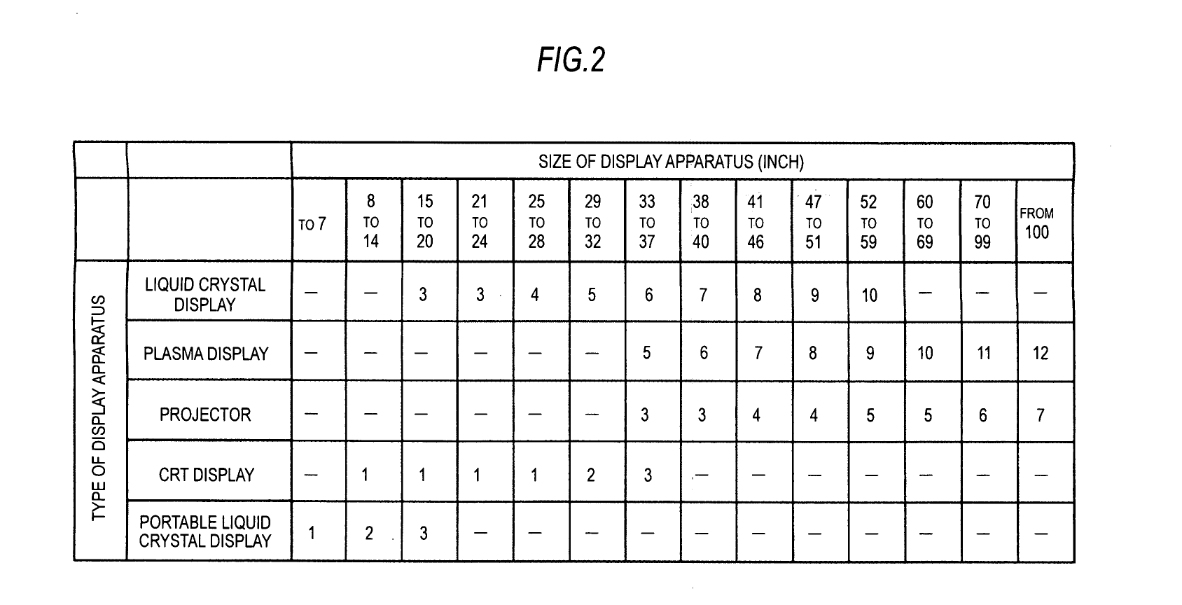

FIG. 2 is a chart for explaining a filter-intensity determination table used when determining a filter intensity based on display apparatus information acquired from the display apparatus 3.

The filter-intensity determination circuit 210 determines a filter intensity, for example, based on the table as shown in FIG. 2. That is, the filter-intensity determination circuit 210 previously stores the filter-intensity determination table as shown in FIG. 2 and determines a filter intensity by referring to the table.

It is preferable that the filter intensity table experientially determined in advance is stored, for example, at the time of shipping the video playback system 100 and on some other occasions.

The filter intensity correspond to, for example, values from “0” to “12”.

For example, a filter intensity “12” is the highest intensity of filter processing which can be executed by the adaptive filter processing circuit 209, and a filter intensity “0” indicates that filter processing is not performed at all by the adaptive filter processing circuit 209.

The filter intensities represented here are just an example and they are not limited to the example.

They are parameters for relatively representing intensities of filter processing executed by the adaptive filter processing circuit 209.

As shown in FIG. 2, the filter-intensity determination circuit 210 sets the filter intensity to be higher as the size of the display device of the display apparatus 3 becomes larger.

In FIG. 2, a bar (-) represents that the filter intensity is “0” or that a corresponding display does not generally exist.

At the same time, the filter-intensity determination circuit 210 sets the degree of filter intensity in accordance with the type of the display device of the display apparatus 3.

Specifically, for example, in the case of the plasma display and the projector which are generally regarded as having high tolerance for block noise, the filter-intensity determination circuit 210 determines the filter intensity to be “0” with respect to relatively small-sized displays as shown in FIG. 2.

According to this, in the case that the display apparatus 3 belongs to the type in which block noise is not conspicuous as well as the display size is relatively small, it is determined that noise is not conspicuous even when noise removal of video data displayed in the display apparatus 3 is not particularly performed, and the filter processing is not performed.

That is, the filter-intensity determination circuit 210 determines not to perform filter processing because the above is the case in which it is anticipated that a disadvantage (lowering of picture quality) is more prominent than an advantage by removing noise.

On the other hand, the filter-intensity determination circuit 210 determines that the filter processing is performed from a display having relatively smaller size in the case of the liquid crystal display in which noise is regarded as conspicuous. The filter intensity is determined to be higher in the display having the same size, as compared with the plasma display or the projector.

Particularly, the filter-intensity determination circuit 210 determines that a portable-type liquid crystal display having the size less than 20 inches will have the filter intensity in accordance with the screen size.

In the case of the CRT display in which noise is regarded as inconspicuous, displays having the size more than inches scarcely exist, therefore, the filter intensities for CRT displays having the size smaller than that are determined to be lower as compared with the liquid crystal display.

As described above, in the video playback system 100 according to the first embodiment, the adaptive filter processing circuit 209 performs filter processing for removing noise in a process of decoding inputted video data in the video playback apparatus 2. The filter processing is performed in the filter intensity determined by the filter-intensity determination circuit 210. The filter-intensity determination circuit 210 acquires display apparatus information which is information indicating the type, size and the like of the display device of the display apparatus 3 by performing communication with the type notification unit 33 of the display apparatus 3, and determines the filter intensity by referring to the filter-intensity determination table.

Here, the filter-intensity determination table is a table in which filter intensities which have been previously determined in accordance with the type and size of display apparatuses are written. In this table, filter processing is set not to be performed with respect to displays having relatively small sizes in display apparatuses which belong to the type in which noise is regarded as inconspicuous. Also in the table, the filter intensity is set to be higher with respect to the display in the display apparatus which belongs to the type in which noise is regarded as conspicuous, as compared with the display having the same size in the display apparatus which belongs to the type in which noise is inconspicuous.

Accordingly, the adaptive filter processing circuit 209 performs filter processing based on the filter intensity determined by the filter-intensity determination circuit 210 in accordance with the type and size of the display apparatus 3, therefore, filter processing corresponding to characteristics the display apparatus 3 can be executed.

Consequently, the video playback system 100 according to the first embodiment is configured to avoid problems such that video is blurred due to excessive filter processing or that noise is conspicuous because the intensity of filter processing is too low. According to this, it is possible to properly remove noise generated at the time of playing back coded video.

### Second Embodiment

Hereinafter, a video playback system 100a according to a second embodiment will be explained.

The video playback system 100a according to the second embodiment which will be explained below has the same components as the video playback system 100 of the first embodiment except part thereof. In the video playback system 100a according to the second embodiment, the same components as the video playback system 100 of the first embodiment perform the same operations as explained in the first embodiment.

Therefore, the difference between the video playback system 100a according to the second embodiment and the video playback system 100 according to the first embodiment will be explained below.

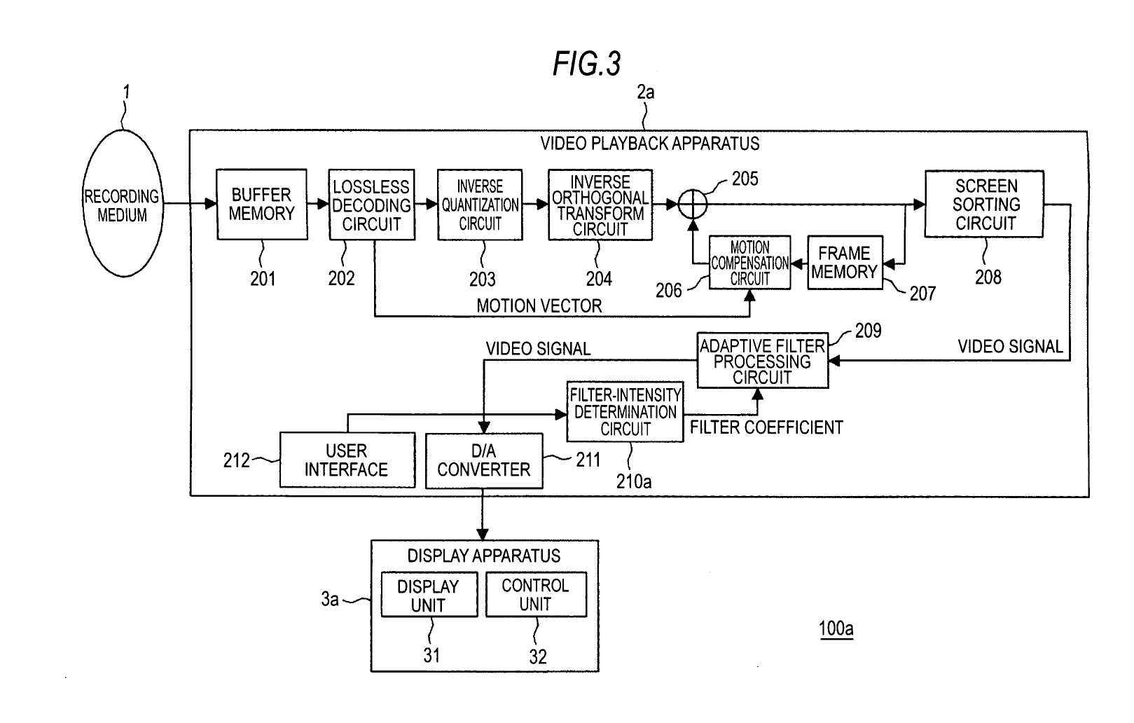

FIG. 3 is a block diagram showing a configuration example of the video playback system 100a according to the second embodiment.

As shown in FIG. 3, the video playback system 100a according to the second embodiment includes a recording medium 1, a video playback apparatus 2a and a display apparatus 3a.

The video playback apparatus 2a includes the same components as the video playback system 100 of the first embodiment except a filter-intensity determination circuit 210a and a user interface 212.

Also as shown in FIG. 3, the display apparatus 3a has the same components as the display apparatus 3 of the first embodiment except a point that the type notification unit 33 is not included.

In the second embodiment, the user interface 212 is an interface device for inputting display apparatus information concerning the display apparatus 3a connected to the video playback apparatus 2a by the user.

The user interface 212, for example, can previously read display apparatus information concerning display apparatuses which are candidates to be connected to the video playback apparatus 2a from a memory not shown in FIG. 3, and can allow the user to select which display apparatus has been connected.

Specifically, the user interface 212 displays display apparatus information concerning display apparatuses which are candidates to be connected to the video playback apparatus 2a on a display unit not shown in FIG. 3, and allows the user to select the display apparatus (to be) connected among them.

As a method of allowing the user to select the display apparatus by the user interface 212, for example, there are a method in which type names of display apparatuses are displayed in a list to allow the user to select the type name, and a method in which the type and size are allowed to be selected separately.

In the method of allowing the user to select the type name, it is necessary that information of type names, types and sizes are stored in the video playback apparatus 2a in advance. The information may be stored, for example, in the memory not shown in FIG. 3.

Accordingly, the user interface 212 can allow the user to input the display apparatus information such as the type, size of the display apparatus connected to the video playback apparatus 2a to obtain the information.

The user interface 212 transmits the obtained display apparatus information to the filter-intensity determination circuit 210a.

As described above, the filter-intensity determination circuit 210a determines a filter intensity based on the display apparatus information obtained through the user interface 212, which is different from the filter-intensity determination circuit 210 of the first embodiment.

The method of determining filter intensity of the filter-intensity determination circuit 210a based on display apparatus information is the same as the method, for example, explained in the first embodiment.

That is, the filter intensity may be determined by referring to the table which has been previously stored and display apparatus information.

As described above, in the video playback system 100a according to the second embodiment, the filter intensity is determined based on display apparatus information obtained by user through the user interface 212 without obtaining display apparatus information from the display apparatus by the filter-intensity determination circuit 210a.

Therefore, even when the display apparatus 3a does not include a means for transmitting display apparatus information indicating the type and size of the display device of itself to the video playback apparatus 2a, the video playback apparatus 2a can obtain display apparatus information of the display apparatus 3a and can determine the filter intensity.

According to this, usability of the video play back system 100a according to the second embodiment is improved.

### Third Embodiment

Hereinafter, a video playback system 100b according to a third embodiment will be explained.

The video playback system 100b according to a third embodiment which will be explained below has the same components as the video playback system 100 of the first embodiment except part thereof. In the video playback system 100b according to the third embodiment, the same components as the video playback system 100 of the first embodiment perform the same operations as explained in the first embodiment.

Therefore, the difference between the video playback system 100b according to the third embodiment and the video playback system 100 according to the first embodiment will be explained below.

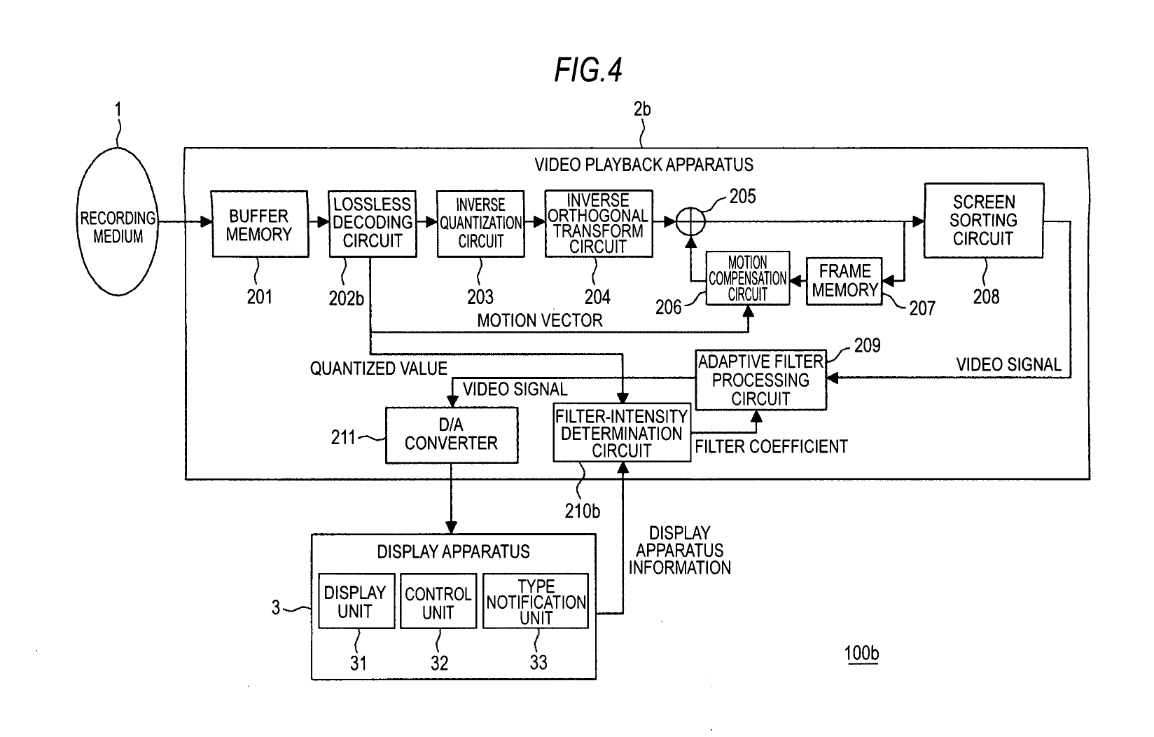

FIG. 4 is a block diagram showing a configuration example of a video playback system 100b according to the third embodiment.

As shown in FIG. 4, the video playback system 100b according to the third embodiment includes a recording medium 1, a video playback apparatus 2b and a display apparatus 3.

The video playback apparatus 2b includes the same components as the video playback system 100 of the first embodiment except a lossless decoding circuit 202b and a filter-intensity determination circuit 210b.

Also as shown in FIG. 4, the display apparatus 3 includes the same components as the display apparatus 3 of the first embodiment, which is different from the second embodiment.

In the video playback system 100b according to the third embodiment, the lossless decoding circuit 202b outputs a calculated quantized value to the filter-intensity determination circuit 210b.

Then, the filter-intensity determination circuit 210b determines a filter intensity based on display apparatus information acquired from the type notification unit 33 of the display apparatus 3 and the quantized value obtained from the lossless decoding circuit 202b.

That is, the filter-intensity determination circuit 210b determines the filter intensity by adding change based on the quantized value, with respect to the filter intensity determined by the filter intensity table based on the display apparatus information obtained from the type notification unit 33 of the display apparatus 3.

Specifically, the filter-intensity determination circuit 210b determines a definitive filter intensity, for example, by increasing the filter intensity by a given value when the quantized value is higher than a given threshold value or reducing the filter intensity by a given value when the quantized value is lower than the given threshold value.

According to the quantized value, it is possible to know to what degree the quantization has been performed by the macroblock in video data. Therefore, the filter-intensity determination circuit 210b determines that a quantization error is larger, namely, that the noise level is higher as the quantized value becomes higher, setting the filter intensity to be higher. Conversely, when the quantization value is low, the quantization error is small and the noise level is also low, therefore, the filter intensity may be determined to be lower.

The width of values in which filter intensity is changed by the filter-intensity determination circuit 210b based on the quantized value may be a predetermined value or may be values according to the size of quantized value. That is, it is preferable that the filter intensity is set to be higher as the quantized value becomes higher and that the filter intensity is set to be lower as the quantized value becomes lower.

As a unit in which the filter intensity is changed in accordance with the quantized value, for example, a unit of a frame of video data, a unit of GOP (Group of Pictures), a unit of a prescribed divided area of video data and the like can be cited. It is also preferable that the quantized value is acquires by a unit of time, and filter intensity is changed in accordance with the value.

As described above, in the video playback system 100b of the third embodiment, the filter-intensity determination circuit 210b changes the value of the filter intensity which is determined based on display apparatus information obtained from the display apparatus 3 in accordance with the quantized value.

Therefore, the determined filter intensity is optimum for the display apparatus 3 in which video data is displayed, in addition, the filter intensity is controlled in accordance with the degree of the quantized error in the same frame, as a result, accuracy in noise removal is improved.

### Fourth Embodiment

Hereinafter, a video playback system 100c according to a fourth embodiment will be explained.

The video playback system 100c according to the fourth embodiment explained below includes components in which the above-described second embodiment and third embodiment are combined.

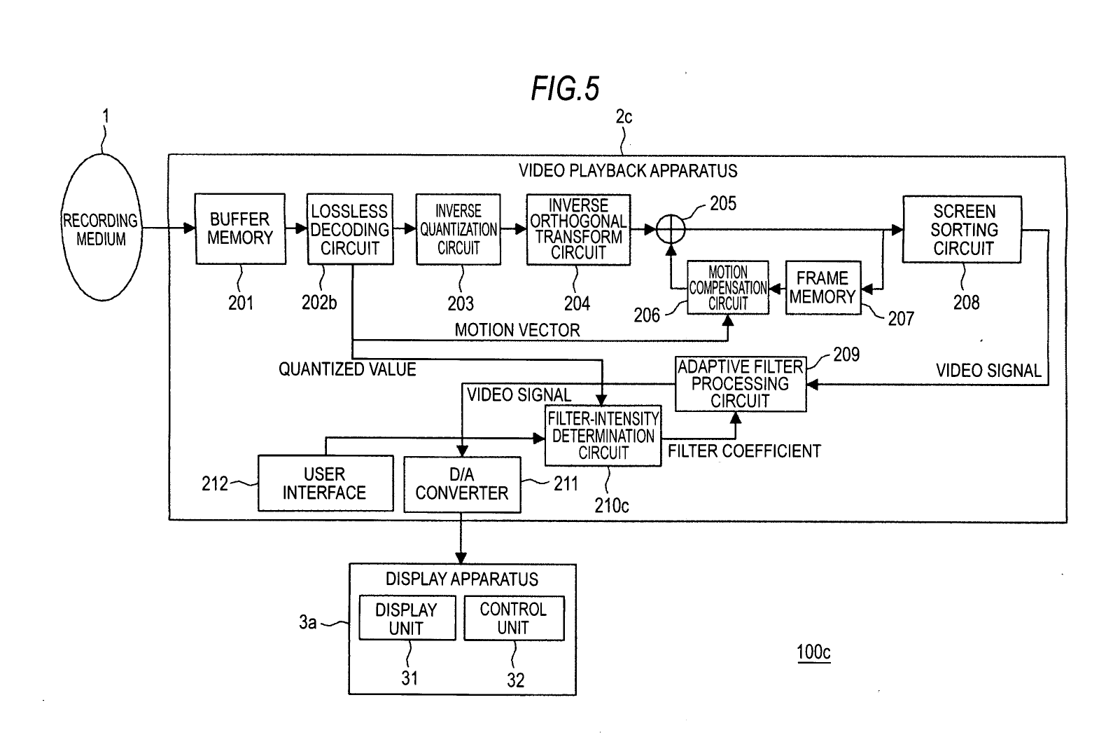

FIG. 5 is a block diagram showing a configuration example of the video playback system 100c according to the fourth embodiment.

As shown in FIG. 5, the video playback system 100c according to the fourth embodiment includes a recording medium 1, a video playback apparatus 2c and a display apparatus 3a.

The video playback apparatus 2c has the same configuration as the video playback apparatus 2a of the second embodiment in a point that the user interface 212 is included. The video playback apparatus 2c also has the same configuration as the video playback system 100b of the third embodiment in a point that the quantized value is outputted to the filter-intensity determination circuit 210c from the lossless decoding circuit 202b.

Also as shown in FIG. 5, the display apparatus 3a is different from the third embodiment and has the same configuration as the display apparatus 3a of the second embodiment. That is, the type notification unit 33 is not included.

In the video playback system 100c according to the fourth embodiment, the lossless decoding circuit 202b outputs the calculated quantized value to the filter-intensity determination circuit 210c in the same manner as the third embodiment.

The filter-intensity determination circuit 210c determines a filter intensity based on display apparatus information and acquired from the user interface 212 and the quantized value acquired from the lossless decoding circuit 202b.

That is, the filter-intensity determination circuit 210c determines a filter intensity by adding change based on the quantized value, with respect to the filter intensity determined by the filter intensity table based on the display apparatus information obtained from the user interface 212.

Specifically, the filter-intensity determination circuit 210c determines a definitive filter intensity, for example, by increasing the filter intensity by a given value when the quantized value is higher than a given threshold value or reducing the filter intensity by a given value when the quantized value is lower than the given threshold value.

The width of values in which filter intensity is changed by the filter-intensity determination circuit 210c based on the quantized value may be a predetermined value or may be values according to the size of the quantized value. That is, it is preferable that the filter intensity is set to be higher as the quantized value becomes higher and that the filter intensity is set to be lower as the quantized value becomes lower.

As a unit in which the filter intensity is changed in accordance with the quantized value, for example, a unit of a frame of video data, a unit of GOP (Group of Pictures), a unit of a prescribed divided area of video data and the like can be cited.

As described above, in the video playback system 100c of the fourth embodiment, the filter-intensity determination circuit 210c changes the value of the filter intensity determined based on display apparatus information acquired from the user interface 212 in accordance with a quantized value.

Accordingly, the accuracy in noise removal is improved by performing filter processing of the video playback apparatus 2c.

The invention is not limited to the above-described embodiments.

That is, when the invention is put into practice, various modification and alternations may occur concerning components of the above embodiments within the technical scope or the scope equivalent thereto.

In the above first to fourth embodiments, display apparatus information is cited as parameters for determining the filter intensity by the filter-intensity determination circuit. According to the above embodiment, the types of display apparatuses and the sizes of displays are cited as display apparatus information, however, the invention is not limited to this. That is, it is preferable that any one of the type and the size is used as well as preferable that an index indicating whether noise is conspicuous or not in the display apparatus other than the type and size is used as a parameter.

It should be understood by those skilled in the art that various modifications, combinations, sub-combinations and alterations may occur depending on design requirements and other factors insofar as they are within the scope of the appended claims or the equivalents thereof.

What is claimed is:

1. A video display system comprising:
a video playback apparatus executing playback processing of video data and filter processing for removing noise from the video data; and
a display apparatus performing display processing displaying video data played back by the video playback apparatus, and
wherein video playback apparatus includes
an adaptive filter processing circuit executing the filter processing to the video data and
a filter-intensity determination circuit determining a filter intensity which is an intensity of the filter processing, and
wherein the display apparatus includes
a type notification unit transmitting display apparatus information which is information indicating the type of the display apparatus and/or the size of the display apparatus to the video playback apparatus, and
wherein the filter-intensity determination circuit determines the filter intensity based on the display apparatus information transmitted from the type notification unit.

2. The video display system according to claim 1,
wherein the filter-intensity determination circuit sets the filter intensity to be higher as the size of the display apparatus becomes larger, and sets the filter intensity to be lower as the size of the display apparatus becomes smaller.

3. A video display system comprising:
a video playback apparatus executing playback processing of video data and filter processing for removing noise from the video data; and
a display apparatus performing display processing displaying video data played back by the video playback apparatus, and
wherein video playback apparatus includes
an adaptive filter processing circuit executing the filter processing to the video data,
a filter-intensity determination circuit determining a filter intensity which is an intensity of the filter processing and
a user interface which can select display apparatus information which is information indicating the type of the display apparatus and/or the size of the display apparatus, and
wherein the filter-intensity determination circuit determines the filter intensity based on the display apparatus information selected by the user interface.

4. A video display system comprising:
a video playback apparatus executing playback processing of video data and filter processing for removing noise from the video data; and
a display apparatus performing display processing displaying video data played back by the video playback apparatus, and
wherein video playback apparatus includes
an adaptive filter processing circuit executing the filter processing to the video data and
a filter-intensity determination circuit determining a filter intensity which is an intensity of the filter processing, and
wherein the display apparatus includes
a type notification unit transmitting display apparatus information which is information indicating the type of the display apparatus and/or the size of the display apparatus to the video playback apparatus, and
wherein the filter-intensity determination circuit determines the filter intensity based on the display apparatus information transmitted from the type notification unit and changes the filter intensity determined based on a quantized value calculated in the playback processing.

5. The video display system according to claim 4,
wherein the filter-intensity determination circuit determines the degree in which the filter intensity is changed in accordance with the size of the quantized value when changing the determined filter intensity based on the quantized value.

6. The video display system according to claim 5,
wherein the filter-intensity determination circuit acquires the quantized value by a unit of time.

7. The video display system according to claim 6,
wherein the filter-intensity determination circuit acquires the quantized value by a unit of a prescribed area obtained by dividing each frame of video data.

8. A video display system comprising:
a video playback apparatus executing playback processing of video data and filter processing for removing noise from the video data; and
a display apparatus performing display processing displaying video data played back by the video playback apparatus, and
wherein video playback apparatus includes
an adaptive filter processing circuit executing the filter processing to the video data,
a filter-intensity determination circuit determining a filter intensity which is an intensity of the filter processing and
a user interface which can select display apparatus information which is information indicating the type of the display apparatus and/or the size of the display apparatus, and
wherein the filter-intensity determination circuit determines the filter intensity based on the display apparatus information selected by the user interface and changes the filter intensity determined based on a quantized value calculated in the playback processing.

9. A video playback apparatus, connected to a display apparatus which performs display processing displaying video data and executing playback processing of video data and filter processing for removing noise from the video data, the video playback apparatus comprising:
an adaptive filter processing circuit; and
a filter-intensity determination circuit determining a filter intensity which is an intensity of the filter processing, and
wherein the filter-intensity determination circuit determines the filter intensity based on display apparatus information which is information indicating the type of the display apparatus and/or the size of the display apparatus, which is transmitted from the display apparatus.

10. A display apparatus connected to a video playback apparatus executing playback processing of video data and filter processing for removing noise from the video data, comprising:
a type notification unit notifying display apparatus information indicating the type of the display apparatus and/or the size of the display apparatus, which is information for determining a filter intensity as a filter processing intensity at the time of executing the filter processing with respect to the video data.
